(19) United States
(12) Patent Application Publication
(10) Pub. No.: US 2022/0040810 A1
(43) Pub. Date: Feb. 10, 2022

(54) HAND-HELD MACHINE TOOL

(71) Applicant: Festool GmbH, Wendlingen (DE)

(72) Inventors: Johann Schlosser, Erkenbrechtsweiler (DE); Simon Groeger, Plochingen (DE); Hans-Peter Albrecht, Wendlingen (DE)

(73) Assignee: Festool GmbH, Wendlingen (DE)

(21) Appl. No.: 17/414,405

(22) PCT Filed: Oct. 16, 2020
(86) PCT No.: PCT/EP2020/079149

§ 371 Date: Jun. 16, 2021

(30) Foreign Application Priority Data
Nov. 5, 2019 (DE) 20 2019 106 152.9

(51) Int. Cl. B24B 7/18

(52) U.S. Cl. CPC B24B 7/184

(57) ABSTRACT

The invention relates to a handheld machine tool, in particular a surface-finishing machine that includes a machining head, a handle part, and a connection arrangement which connects the machining head to the handle part, a tube outlet for connecting a tube being formed on the connection arrangement or on the handle part, a tube-holding device for holding the tube being provided on the handle part so as to be spaced apart from the tube outlet.

### BACKGROUND

The invention relates to a handheld machine tool having the features of the preamble of claim 1.

Handheld machine tools of the type mentioned at the outset are known from the prior art, for example from DE 10 2007 012 394 A1. Surfaces, for example on walls and ceilings, can be machined using such a machine tool, it being possible for the resulting swarf to be sucked away via a tube connected to the machine tool. This reduces contamination of the environment that occurs during machining. Power can be supplied to the machine tool in a wired manner, for example by means of a cable guided parallel to the tube.

However, it is problematic that, depending on the machining carried out with the machine tool (e.g. in high wall areas or overhead), the tube and cable can rest uncomfortably on a hand or arm of the machine tool user and chafe, especially in machine tools with a lateral tube outlet. This can lead to adverse effects such as skin injuries (e.g. abrasions) and the like. This impairs the handling of such a machine tool.

The problem addressed by the invention is that of facilitating the handling of a handheld machine tool using simple structural means. It is desirable here for adverse effects caused by tubes or cables to be minimized as much as possible.

### SUMMARY OF THE INVENTION

The invention solves this problem by means of a handheld machine tool having the features of claim 1. The handheld machine tool is characterized in that a tube-holding device for holding the tube is provided on the handle part so as to be spaced apart from the tube outlet, in particular in the longitudinal direction of the handle part.

As a result, adverse effects on the handling of the handheld machine tool are reduced by the tube being guided by means of the tube-holding device. The tube is held in two places by means of the tube outlet and tube-holding device. The tube can therefore be held away from the arm or hand of the user. For example, the tube can be held away from a handle portion of the handle part in an arc. The connection cable for supplying power to the machine tool can also be held or guided in the tube-holding device.

The handheld machine tool can be a surface-finishing machine, in particular a long-neck sander. A long-neck sander can be used to sand walls and ceilings. For example, plasterboard or drywall putty can be sanded or leftover wallpaper can be removed.

The tube can be a suction tube. One end of the tube can be connected to the tube outlet of the machine tool and the other end can be connected to a vacuum cleaner, for example. Swarf can be removed via the tube (flow connection). The tube outlet on the machine tool can be in fluid connection with the machining head, for example by means of a flow channel extending in or parallel to the connection arrangement.

The connection arrangement can be designed in one piece, for example as a connection tube. Optionally, the connection arrangement can be formed by two or more connection parts, for example tubular connection portions, which can be coupled to one another. In the assembled state, the connection parts can form the connection arrangement. By varying the number of connection parts, the connection arrangement can be lengthened or shortened as required.

The handle part refers to the part at which the handheld machine tool can be gripped by a user. The handle part can have at least one handle portion at which a user actually grips the handle part, for example by gripping or grasping with the user's hand.

Further components of the handheld machine tool can be arranged in the handle part, for example one or more operating elements, an electrical connection for power supply and/or a tube outlet for connecting the tube (suction tube). The handle part can have a housing on or in which one, several or all of the above components of the handle part are arranged.

In the context of a preferred embodiment, the tube-holding device can be arranged on a handle portion of the handle part, in particular on an end of the handle portion facing away from the connection arrangement. This facilitates handling since the tube is sufficiently spaced apart from at least part of the handle portion. The tube can thus be guided away from the hand and arm of the user. As already indicated, the handle portion is the portion of the handle part which is provided for a user to grip or surround the handle part in this portion.

In an advantageous manner, the tube-holding device can be designed to be removable from the handle part. In other words, the tube-holding device can be reversibly detached from and attached to the handle part. The tube-holding device can thus be used in a very targeted manner as required. In addition, transport is also facilitated, since the tube-holding device can be removed (less space required).

Specifically, the tube-holding device can be connected to the handle part by means of a (mechanical) plug connection. In other words, a plug connection is provided by means of which the tube-holding device can be connected to the handle part. In the same way, the tube-holding device can be removed from the handle part by detaching the plug connection. A connection between the tube-holding device and the handle part that is both structurally simple and proven is established by means of the plug connection.

The tube-holding device can expediently be rotatably mounted on the handle part. The alignment of the tube-holding device and thus the alignment of the tube with respect to the handle part can thus be adapted. It is conceivable for the tube-holding device to be rotatable relative to the handle part about an axis oriented transversely or orthogonally to the central longitudinal direction of the handle part.

In the context of a preferred embodiment, the tube-holding device can be designed in such a way that it in particular can completely surround or completely surrounds the tube in a holding state (closed state of the tube-holding device). This creates a secure and stable fastening of the tube to the handle part. The tube can therefore be largely prevented from undesirably sliding out, as can occur, for example, with retaining clamps that are open radially outward.

The tube-holding device can advantageously have a base part on which a plug pin is formed, which pin can be inserted into an opening formed in the handle part (the opening matches or corresponds to the plug pin). A structurally simple and stable connection of the tube-holding device to the handle portion is thus established. The plug pin and opening can be designed in such a way that the tube-holding device can be rotated on the handle part, for example by a cylindrical design of the plug pin and opening. When the tube is arranged in the tube-holding device, the base part can surround the tube in portions in relation to the tube circumference.

The tube-holding device can expediently have a holding part, a first end of which is fixed to the base part and the second end of which can be detachably connected to the base part. Thus, by guiding the holding part around the tube and fastening or detaching the second end of the holding part to or from the base part, the tube can be secured to or removed from the tube-holding device in a simple manner. When the tube is arranged in the tube-holding device, the holding part can largely surround the tube in relation to the tube circumference. Together, the base part and the holding part can completely surround the tube in the circumferential direction.

Two fastening regions can be formed on the base part. At a first fastening region, the first end of the holding part can be fixed to the base part. At the second fastening region, the second end of the holding part can be detachably connectable to the base part. The first fastening region and the second fastening region can be arranged on opposite sides of the plug connection or the plug pin (the latter can be located between the two fastening regions).

In the context of a preferred embodiment, the first end of the holding part cannot be detached from the base part in a non-destructive manner. This results in a particularly stable connection of the holding part to the base part. Protection against loss is achieved in this way.

Specifically, the holding part can be designed as a bail that can be pivoted relative to the base part. This contributes to a stable design of the holding part. The bail can, for example, be designed as a metal bail or a plastics bail.

Alternatively, the holding part can be designed as a rubber band (which is not endless, i.e. a rubber band having two ends). This creates a holding part which, due to its elasticity, can be adapted to a tube to a certain extent. A connection cable can also be surrounded by the holding part, for example. In addition, the rubber band can have an anti-slip effect on the tube. In this way, unwanted slipping of the tube in the tube-holding device can be avoided.

Advantageously, the rubber band can have one or more, in particular laterally closed, passages at the second end, by means of which the rubber band can be detachably connected to a preferably hook-shaped fastening portion formed on the base part. This contributes to a structurally simple fastening of the second end of the rubber band to the base part. If there is a plurality of passages, the diameter of the holding part or the tube-holding device can be adapted.

The preferably hook-shaped fastening portion can be arranged in the second fastening region of the base part. The fastening portion can, for example, be designed as a radially outwardly open hook portion to which the second end of the holding part or of the rubber band can be detachably connected.

On the base part, in particular in the first fastening region of the base part, a hook portion can be formed which is radially outwardly closed and to which the first end of the holding part or of the rubber band is fixed. The fastening is in particular designed in such a way that the holding part or the rubber band cannot be detached from the hook portion in a non-destructive manner.

In the context of a preferred embodiment, the handle part can have a T-shaped handle portion, in each of the narrow sides of which (at the lateral ends of the horizontal line of the “T”) an opening for inserting the plug pin of the base part is formed. This facilitates flexible adaptation of the tube guide since the tube-holding device can be inserted into the T-shaped handle portion on both sides. The transversely oriented part of the T-shaped handle portion (the horizontal line of the “T”) protrudes laterally beyond other parts of the handle portion in relation to the central longitudinal direction of the handle part. The tube can thus be guided so as to be laterally spaced apart from the handle part or the handle portion.

As already indicated, the handle part can have a handle portion. An additional handle portion can adjoin this handle portion, in particular at the end of the (first) handle portion facing away from the connection arrangement. This facilitates flexible handling of the handheld machine tool. In addition to gripping with only one hand in one of the handle portions, two-handed gripping of the handle portions is also possible (“two-hand operation”).

Advantageously, one or more openings for inserting the plug pin of the base part can be formed in the additional handle portion. This again increases the flexibility of the tube guide since the tube-holding device can also be fastened in or inserted into the additional handle portion.

Expediently, the additional handle portion can also be T-shaped, with an opening for inserting the plug pin of the base part being formed on the narrow sides of said portion (at the lateral ends of the horizontal line of the “T”). This facilitates flexible adaptation of the tube guide since the tube-holding device can be inserted into the T-shaped handle portion on both sides. The transversely oriented part of the T-shaped handle portion (the horizontal line of the “T”) protrudes laterally beyond other parts of the handle portion in relation to the central longitudinal direction of the handle part. The tube can thus be guided so as to be laterally spaced apart from the handle part or the handle portion.

The problem mentioned at the outset is also solved by a tube-holding device for a handheld machine tool having the features of the additional independent claim. With regard to the advantages that can be achieved in this way, reference is made to the relevant embodiments of the handheld machine tool.

### BRIEF DESCRIPTION OF THE DRAWINGS

The invention is explained in more detail below with reference to the drawings, the same or functionally similar elements being provided with identical reference signs, but in some cases only once. In the drawings:

FIG. 1 shows an embodiment of the handheld machine tool with the tube connected in a perspective view from one side;

FIG. 2 shows the machine tool from FIG. 1 with the tube connected in a perspective view from below;

FIG. 3 shows the machine tool from FIG. 1 without a tube in a perspective view from the side;

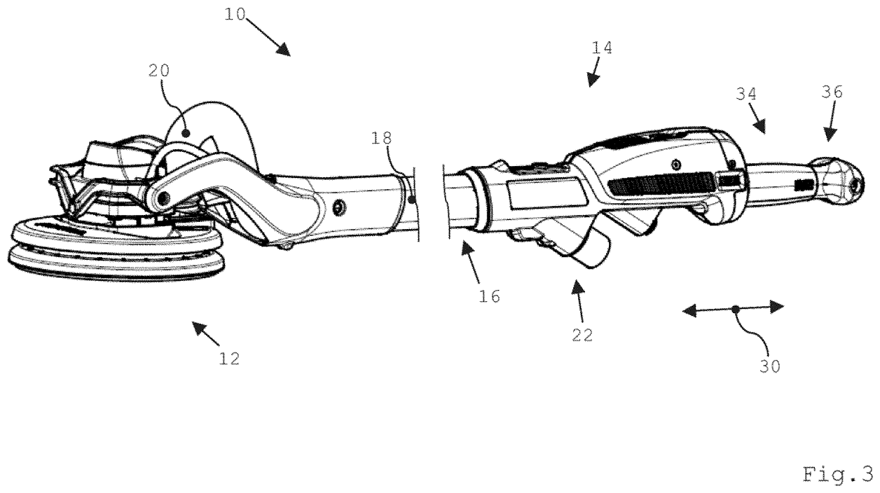

FIG. 4 shows the handle portion and the tube-holding device of the machine tool from FIG. 1 in an enlarged perspective view (tube-holding device closed);

FIG. 5 shows the handle portion and the tube-holding device from FIG. 4 in a perspective view from above (tube-holding device closed);

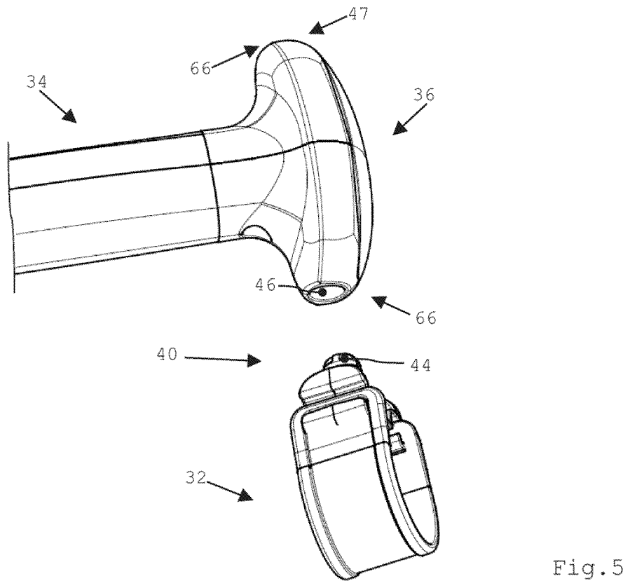

FIG. 6 shows the tube-holding device of the handheld machine tool from FIG. 1 in a perspective view in isolation (tube-holding device open); and

FIG. 7 shows an embodiment of the handheld machine tool from FIG. 1 with two handle portions in a perspective view from one side.

### DETAILED DESCRIPTION

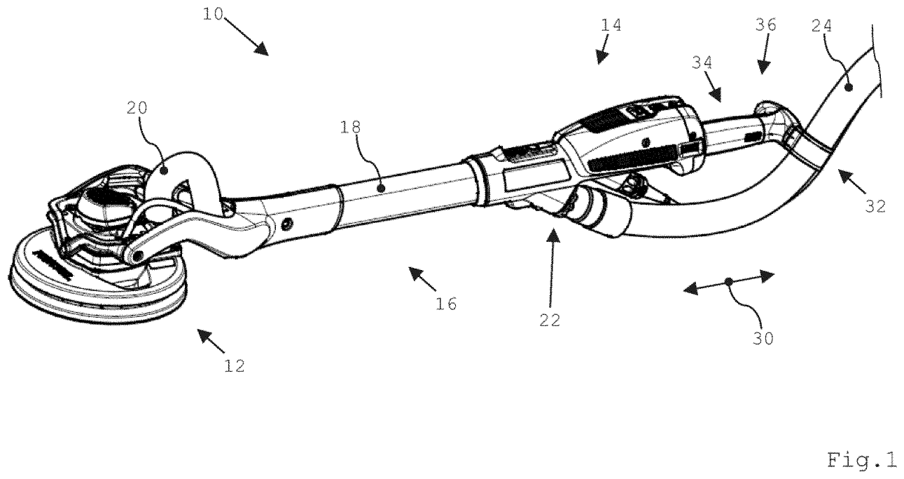

FIG. 1 shows a handheld machine tool which is designated as a whole with the reference sign 10 (hereinafter referred to as “machine tool 10”). The machine tool 10 can be a surface-finishing machine 10 such as, for example, a long-neck sander.

The machine tool 10 has a machining head 12, a handle part 14, and a connection arrangement 16 which connects the machining head 12 to the handle part 14.

The connection arrangement 16 has a connection part 18 which is connected to the machining head 12 and can be coupled to the handle part 14. The connection part 18 can, for example, be designed as a tubular portion. Operating elements and/or display elements (not shown) can be arranged on the handle part 14.

A tube portion 20, one end of which is in fluid connection with a suction point (not shown) on the machining head 12, is arranged on the machining head 12. At the other end, the tube portion 20 is in fluid connection, specifically via a flow channel (not shown) formed in the connection part 18, with a tube outlet 22 which is formed on the handle part 14.

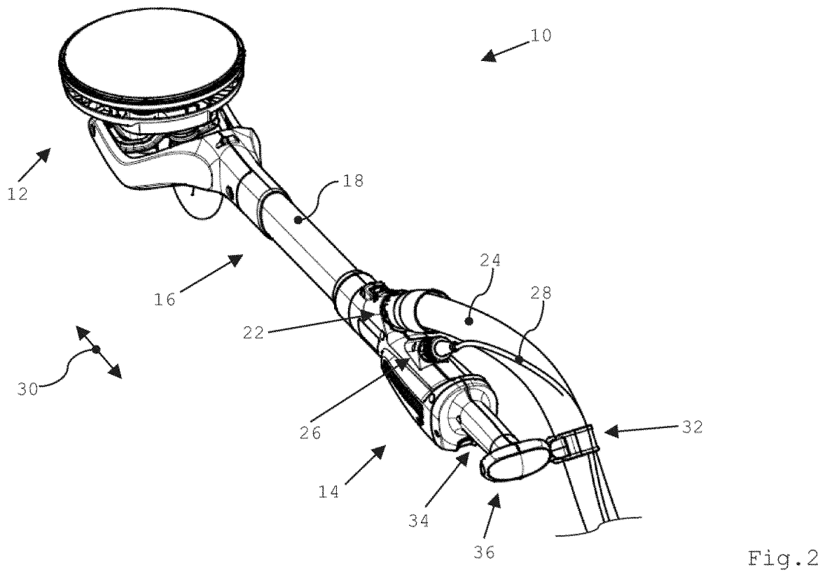

A tube 24 (suction tube 24) is connected to the tube outlet 22. The other end of the tube 24 can, for example, be connected to a vacuum cleaner (not shown), so that swarf can be sucked away from the suction point on the machining head 12. In addition, an electrical connection 26, to which a connection cable 28 can be connected to supply power to the machine tool 10, is provided on the handle part 14 (cf. FIG. 2). The other end of the connection cable 28 can be connected to a socket (not shown), for example.

A tube-holding device 32 for holding the tube 24 is provided on the handle part 14 so as to be spaced apart from the tube outlet 22 in the longitudinal direction 30. The connection cable 28 can optionally also be held in the tube-holding device 32 (cf. FIG. 2).

In the present embodiment, the tube-holding device 32 is arranged on a handle portion 34 of the handle part 14, specifically on an end 36 of the handle portion 34 facing away from the connection arrangement 16.

The tube-holding device 32 is designed to be removable from the handle part 14. The tube-holding device 32 can be reversibly detached from and fastened to the handle part 14, so that said device can be used for fastening or guiding the tube 24 as necessary.

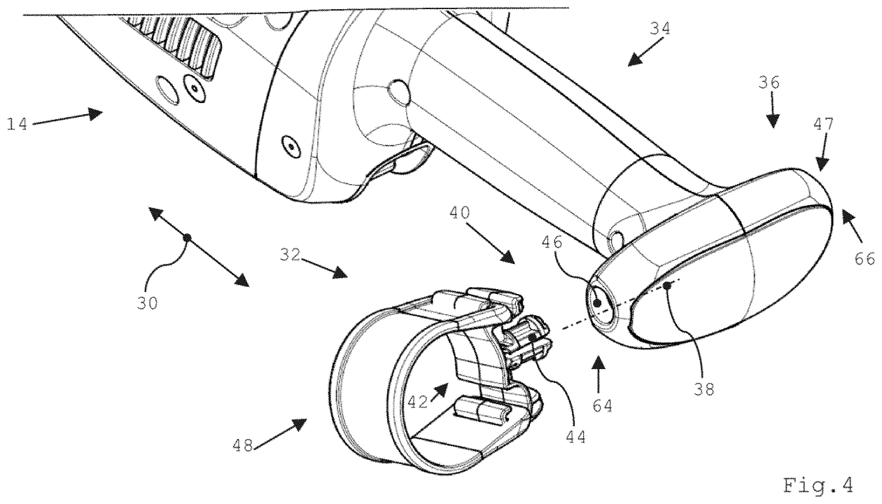

The tube-holding device 32 is rotatably mounted on the handle part 14, specifically about an axis 38 (see FIG. 4). The axis 38 is oriented transversely to the longitudinal direction 30. The tube-holding device 32 is designed in such a way that, in a holding state (when the tube-holding device 32 is closed), it completely surrounds the tube 24 (see FIGS. 1 and 2). The tube-holding device 32 can be reversibly connected to the handle part 14 by means of a mechanical plug connection 40 (see FIG. 4).

The tube-holding device 32 has a base part 42 on which a plug pin 44 is formed, which plug pin can be inserted into a matching opening 46, 47, i.e. an opening which corresponds to the plug pin 44, formed in the handle part 14. If the tube 24 is inserted in the tube-holding device 32, the base part 42 surrounds the tube 24 in portions in relation to the circumferential direction of the tube 24.

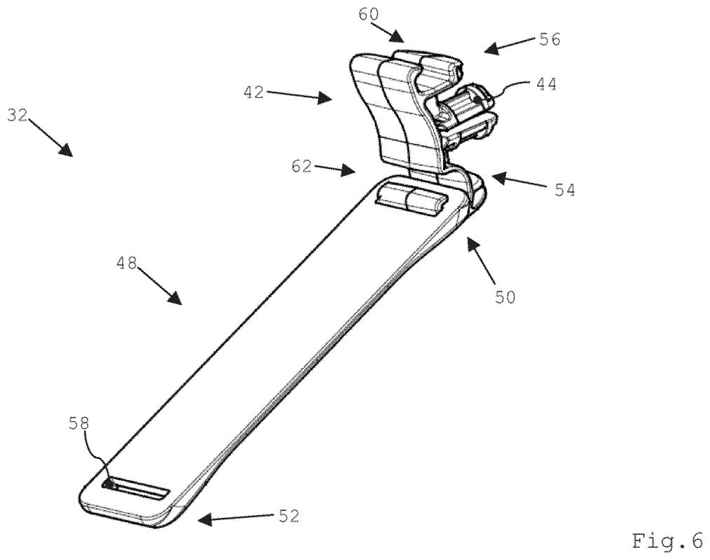

The tube-holding device 32 also has a holding part 48, a first end 50 of which is fixed to the base part 42 and the second end 52 of which can be detachably connected to the base part 42 (see in particular FIG. 6).

Two fastening regions 54, 56 are formed on the base part 42. In the first fastening region 54, the first end 50 of the holding part 48 is fixed to the base part 42. In the second fastening region 56, the second end 52 of the holding part 48 can be detachably connected to the base part 42. The first fastening region 54 and the second fastening region 56 are arranged on opposite sides of the plug pin 44.

The first end 50 of the holding part 48 cannot be detached from the base part 42 in a non-destructive manner.

In embodiments that are not shown, the holding part 48 can be designed as a bail (not shown) that can be pivoted relative to the base part 42.

In the present embodiment, the holding part 48 is designed as a rubber band having two ends 50, 52. At the second end 52, the rubber band has one or more passages 58 which are closed laterally (only one passage 58 shown here).

Via the passage or passages 58, the rubber band can be connected to a hook-shaped fastening portion 60, which is arranged in the second fastening region 56 of the base part 42. The hook-shaped fastening portion 60 is designed as a hook portion that is radially outwardly open. Thus, the second end 52 of the holding part 48 or of the rubber band can be mounted on and detached from the hook portion 60.

A radially outwardly closed hook portion 62 is formed in the first fastening region 54 of the base part 42, to which hook portion the first end 50 of the holding part 48 or of the rubber band is fixed. The holding part 48 or the rubber band cannot be detached from the hook portion 62 in a non-destructive manner. This ensures that the holding part 48 or the rubber band always stays together (protection against loss).

The handle portion 34 of the handle part 14 is T-shaped (T-shaped handle portion 34). On each of the narrow sides 64, 66 (lateral ends of the horizontal line of the “T”), an opening 46, 47 for inserting the plug pin 44 of the base part 42 is formed. The base part 42 can optionally be inserted into the opening 46 or the opening 47 (assembly possible on both sides). As already explained above, the handle portion 34 is the portion of the handle part 14 which is designed to be gripped or surrounded by a user's hand.

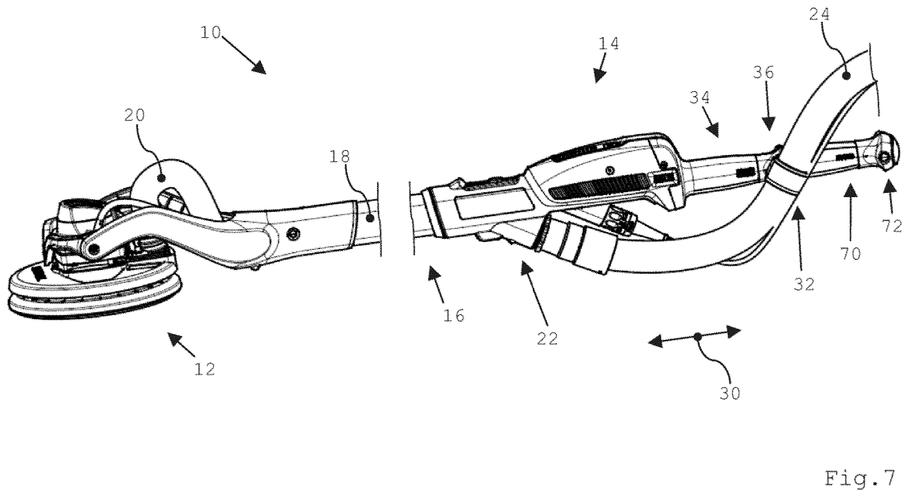

FIG. 7 shows an embodiment of the machine tool 10 which largely corresponds to the embodiment described above. To avoid repetition, reference is therefore made to the above embodiments (the same or functionally similar elements are provided with identical reference signs).

The present machine tool 10 also comprises a handle part 14 which has a handle portion 34. An additional handle portion 70 adjoins this handle portion 34 at the end 36 facing away from the connection arrangement 16. The machine tool 10 thus has two handle portions 34, 70.

One or more openings 72 for inserting the plug pin 44 of the base part 42 are formed on the additional handle portion 70 (only one opening 72 is provided with a reference sign). The tube-holding device 32 can thus also be inserted into the additional handle portion 70.

The additional handle portion 70 is also T-shaped. The openings 72 are each formed on the narrow sides (no reference signs) of the T-shaped handle portion 70.

1. Handheld machine tool, comprising a machining head, a handle part, and a connection arrangement which connects the machining head to the handle part, a tube outlet for connecting a tube being formed on the connection arrangement or on the handle part, wherein a tube-holding device for holding the tube is provided on the handle part so as to be spaced apart from the tube outlet.

2. Machine tool according to claim 1, characterized in that the tube-holding device is arranged on an end of the handle portion facing away from the connection arrangement.

3. Machine tool according to claim 1, wherein the tube-holding device is removable from the handle part.

4. Machine tool according to claim 1, wherein the tube-holding device can be connected to the handle part by means of a plug connection.

5. Machine tool according to claim 1, wherein the tube-holding device is rotatably mounted on the handle part.

6. Machine tool according to claim 1, wherein the tube-holding device is designed such that it surrounds or can surround the tube in a holding state.

7. Machine tool according to claim 1, wherein the tube-holding device has a base part on which a plug pin is formed, which plug pin can be inserted into an opening formed in the handle part.

8. Machine tool according to claim 1, wherein the tube-holding device has a holding part, a first end of which is fixed to the base part and the second end of which can be detachably connected to the base part.

9. Machine tool according to claim 8, wherein the first end of the holding part cannot be detached from the base part in a non-destructive manner.

10. Machine tool according to claim 8, wherein the holding part is designed as a bail which can be pivoted relative to the base part.

11. Machine tool according to claim 8, wherein the holding part is designed as a rubber band.

12. Machine tool according to claim 11, characterized in that the rubber band has one or more passages at the second end by means of which the rubber band can be detachably connected to a hook-shaped fastening portion formed on the base part.

13. Machine tool according to claim 1, wherein the handle part has a T-shaped handle portion in each of the narrow sides of which an opening for inserting the plug pin of the base part is formed.

14. Machine tool according to claim 1, wherein the handle part has a handle portion and an additional handle portion being connected to said handle portion at an end facing away from the connection arrangement.

15. Machine tool according to claim 14, wherein one or more openings for inserting the plug pin of the base part are formed in the additional handle portion.

16. Machine tool according to claim 14, wherein the additional handle portion is T-shaped and includes narrow sides, an opening for inserting the plug pin of the base part being formed on each of the narrow sides of the portion.

17. Tube-holding device for a handheld machine tool wherein the handheld machine tool comprises a machining head, a handle part, and a connection arrangement which connects the machining head to the handle part, a tube outlet for connecting a tube being formed on the connection arrangement or on the handle part, wherein a tube-holding device for holding the tube is provided on the handle part so as to be spaced apart from the tube outlet.
